(19) United States
(12) Patent Application Publication
(10) Pub. No.: US 2011/0113932 A1
(43) Pub. Date: May 19, 2011

(54) AIR FRAME FASTENER INSTALLATION TOOL

(75) Inventors: David Lambert, Rincon, GA (US); Melissa Hibbard Lambert, Rincon, GA (US)

(73) Assignee: OMEGA TECHNOLOGIES, INC., Westlake Village, CA (US)

(21) Appl. No.: 12/944,577

(22) Filed: Nov. 11, 2010

Related U.S. Application Data
(60) Provisional application No. 61/260,878, filed on Nov. 13, 2009.

(51) Int. Cl. B25B 13/46; B25B 13/48

(52) U.S. Cl. 81/60; 81/125

(57) ABSTRACT

An air frame fastener wrench includes first and second handles pivotally attached to one another. A ratchet head of the first handle includes a selectively rotatable driver mateable with a socket. As the first and second handles are brought towards one another, the driver rotates the mated socket and an engaged collar of an air frame fastener. A key, which is connected to the first or second handle for preventing rotation of the key, extends through the ratchet head and prevents rotation of a pin of the air frame fastener as the collar is tightened thereto.

### BACKGROUND OF THE INVENTION

The present invention generally relates to wrenching tools. More specifically, the present invention relates to an air frame fastener wrench tool which is operable with only one hand.

The aerospace industry has made use of “broached-pin” fastening systems for over fifty years. There are many variations, all having in common a method of keeping the bolt or pin from rotating while a nut element is threaded onto it and tightened. Many of the fastening systems used in the aerospace industry are of the frangible fastener type. One such example is the Hi-Lok® fastening system. Such frangible fasteners are used extensively in the aerospace industry due to their simplicity, consistently controlled preload torque and minimum size and weight.

FIGS. 1-4 illustrate a typical frangible fastening system. A pin 10 is extended through the objects 12 and 14 to be fastened to one another, as illustrated in FIGS. 1 and 2. A threaded portion 16 of the pin extends beyond the aligned objects 12 and 14. The end of the pin has a configured recess 18, typically hexagonal, so that an Allen wrench 20 may be inserted to hold the pin stationary while an internally threaded nut 22 is fastened thereto.

As illustrated in FIGS. 2 and 3, the operator holds the hex key Allen wrench 20 with one hand, while operating a wrench, typically having a socket 24 at an end thereof, to hold the pin 10 in place while the nut 22 is fastened onto the threaded portion 16 thereof.

The nut 22 includes a wrenching ring 26 which is configured to engage the socket 24 and an internally threaded collar portion 28. An intermediate neck portion 30 shears the frangible nut ring portion 26 from the collar 28 when the applied torque exceeds a predetermined torsional loading, as illustrated in FIG. 4. The fasteners are applied with one of a variety of wrenching tools which engage the wrenching ring to apply rotational force to the threaded collar and twist the wrenching ring from the threaded collar when the predetermined torsional loading is exceeded. The break-off torque depends on the depth of the groove in the neck which can be selected to meet different torque requirements.

Access to the head 32 of the bolt or pin is usually not possible, and for reasons of weight saving and aerodynamics, the heads 32 of the fasteners are flat so as to be flush with the skin of the aircraft structure, or only protrude slightly. Moreover, these heads 32 do not have any external “hex” or other shape to grip with a wrench to keep the pin or bolt 10 from rotating and turning. As mentioned above, instead the threaded end 16 of the pin 10 is provided with an internal hex recess into which the hex-Allen key wrench may be inserted. In the past, the hex key was held stationary with one hand, preventing the pin 10 from rotating, while the nut element 22 was tightened. When tightened, the hex key 20 was removed.

One of the problems associated with the current fastening method is that it is always a two-handed operation. One hand works the ratchet wrench having the socket 24, while the other hand holds the hex key 20 to keep the pin 10 from rotating while the nut element 22 is tightened.

Power tools have been developed which incorporate the hex key into the tool. In the same manner, the power tool holds the hex key stationary while the socket is used to thread the nut element 22 onto the threaded end 16 of the pin 10.

However, power tools are relatively large and heavy, requiring relatively open access to the site of the fastener installation. Complex aerospace structures often have fasteners in locations where access is limited, preventing the use of such power tools. During the manufacture of the aircraft, the assembly can be planned in such a way to provide for the required access in many cases. However, once an aircraft is assembled, repairs and modifications are commonly required. Frequently, these repairs and modifications must be accomplished inside the aircraft structure in very hard to reach places where the use of power tools is not feasible. The currently used method of holding the hex key 20 with one hand while operating a ratchet wrench with the other hand also presents challenges in such instances.

Accordingly, there is a continuing need for a small, manually operated tool which can be used to fasten the nut element to the pin or bolt. What is particularly needed is such a tool which can hold the pin or bolt in place and prevent it from rotating while simultaneously tightening the nut element to the desired torque levels using only a single hand. The present invention fulfills these needs, and provides other related advantages.

### SUMMARY OF THE INVENTION

The present invention resides in an air frame fastener wrench. The wrench generally comprises a first handle having a ratchet head at a first end thereof, including a selectively rotatable driver mateable with a socket. A second handle is pivotally attached to the first handle. A biasing member, such as a spring, is connected to the first and second handles and biases the first and second handles away from one another. As the first and second handles are brought towards one another, the driver rotates the mated socket and an engaged collar of an air frame fastener.

A key extending through the ratchet head prevents rotation of a pin of the air frame fastener while the collar is tightened to the pin. The key is connected to the tool, typically the second handle, for preventing rotation of the key. The key extends through the driver for insertion into a corresponding key recess of the pin. The key has a plurality of exterior facets corresponding to a plurality of interior facets of the air frame fastener pin key recess. Preferably, a resilient member interconnects the key and the first or second handle, permitting a limited travel of the key through the ratchet head.

The second handle includes an extension member extending at an acute angle from a shaft of the second handle and pivotally connected to the ratchet end of the first handle. The extension member typically comprises first and second spaced apart plates disposed on top and bottom lands of the ratchet head. The first and second plates each include apertures through which the key and the driver extend.

The ratchet head may comprise a gearless ratchet clutch. The wrench provides sufficient torque to shear a frangible nut portion from the collar of the air frame fastener when the collar and pin are adequately fastened to one another.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a partially cross-sectional and perspective view of a prior art pin and nut element of a frangible air frame fastening system for attaching two objects;

FIG. 2 is a similar view as FIG. 1, illustrating the nut element being fastened to the pin;

FIG. 3 is a view similar to FIG. 2, illustrating the nut element fastened to the pin;

FIG. 4 is a perspective and cross-sectional view illustrating the shearing of the nut ring from the collar once the collar and pin have been fully attached to one another;

FIG. 5 is a top perspective view of the air frame fastener wrench embodying the present invention;

FIG. 6 is a bottom perspective view of the wrench of FIG. 5;

FIG. 7 is an exploded and partially sectioned view of the air frame fastener wrench, illustrating the various component parts thereof;

FIG. 8 is a diagrammatic perspective view of the air frame fastener wrench of the present invention positioned to fasten a collar to a pin of the fastening system;

FIG. 9 is a perspective diagrammatic view similar to FIG. 8, illustrating a user actuating the wrench of the present invention to fasten the collar to the pin, in accordance with the present invention;

FIG. 10 is a bottom plan view of the wrench of the present invention;

FIG. 11 is a bottom plan view similar to FIG. 10, illustrating the handles brought towards one another;

FIG. 12 is a bottom plan view similar to FIG. 11, illustrating the handles brought fully towards one another;

FIG. 13 is a top plan view illustrating the handles biased away from one another, in accordance with the present invention;

FIG. 14 is a partial bottom plan view of the wrench of the present invention, illustrating the handles spaced from one another;

FIG. 15 is a view similar to FIG. 14, illustrating the handles being brought towards one another and a driver and socket being rotated, while a key is not rotated, in accordance with the present invention;

FIG. 16 is a view similar to FIG. 15, illustrating the handles being biased away from one another;

FIG. 17 is a cross-sectional view of a driver, attached socket, and pin of the present invention coming into engagement with a collar of an air frame fastener, positioned over a pin of the air frame fastener;

FIG. 18 is a cross-sectional view similar to FIG. 17, illustrating the socket engaged with the collar and the key engaged with the pin, in accordance with the present invention;

FIG. 19 illustrates the rotation of the driver and socket, while the key immobilizes the pin, in accordance with the present invention;

FIG. 20 is a cross-sectional view similar to FIG. 19, illustrating the shearing of the neck of the collar as the collar and the pin of the air frame fastener are coupled to a predetermined torque;

FIG. 21 is an enlarged cross-sectional view of area “21” of FIG. 20, illustrating the shearing of the neck portion of the collar;

FIG. 22 is a cross-sectional view illustrating a sheared ring portion of a nut element of the air frame fastener as it is removed from the fastened collar and pin;

FIG. 23 is an enlarged cross-sectional view of area “23” of FIG. 22, illustrating the fastened collar and pin;

FIG. 24 is an exploded perspective view of the air frame fastener wrench of the present invention, illustrating assembly thereof to operate in the reverse direction; and

FIG. 25 is a top perspective view of the assembled air frame fastener wrench of FIG. 24.

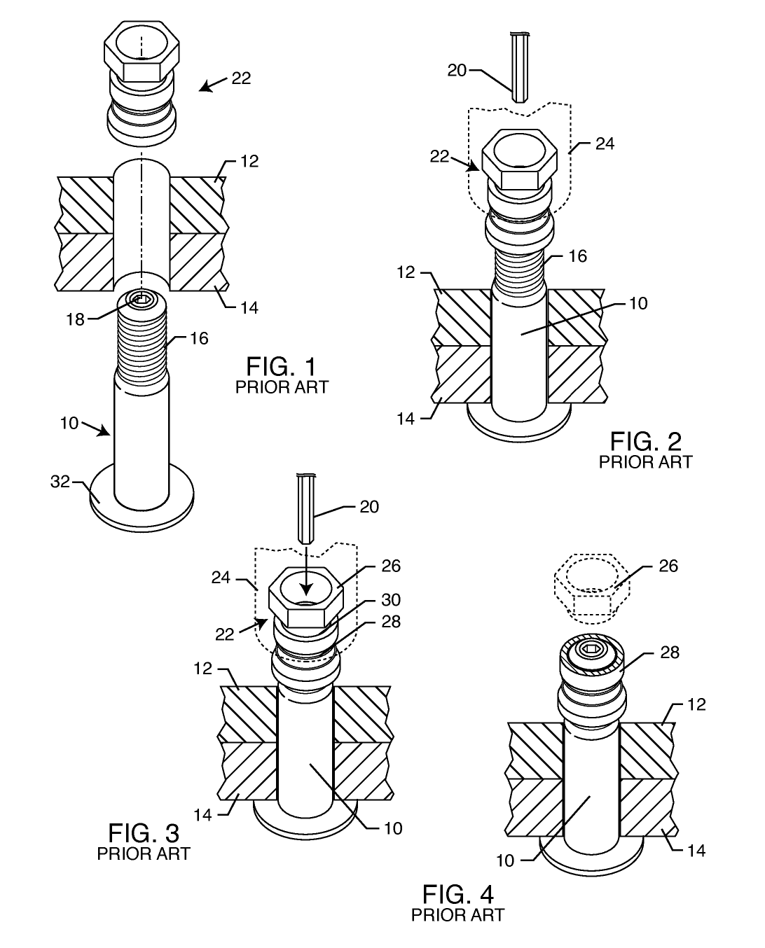

### DETAILED DESCRIPTION OF THE PREFERRED EMBODIMENT

The present invention, as shown in the accompanying drawings for purposes of illustration, is directed to an air frame fastener wrench, generally referred to by the reference number 100. As will be explained more fully herein, the wrench 100 of the present invention is a two-handled wrench which can be operated with a single hand in tight spaces to install or remove components of an air frame fastener.

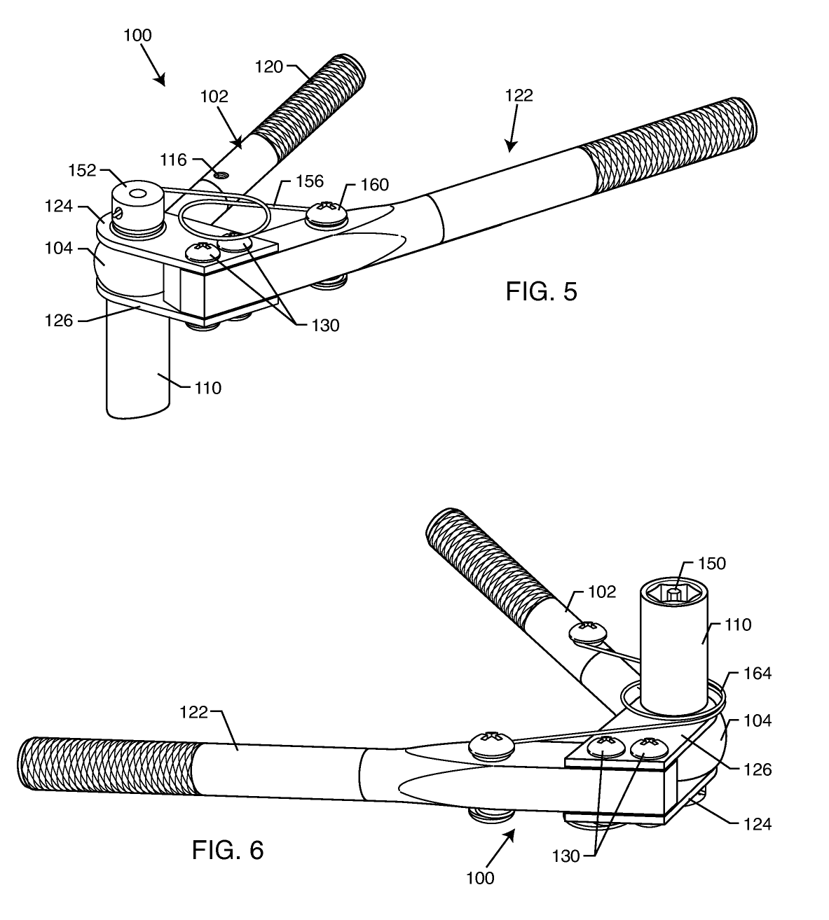

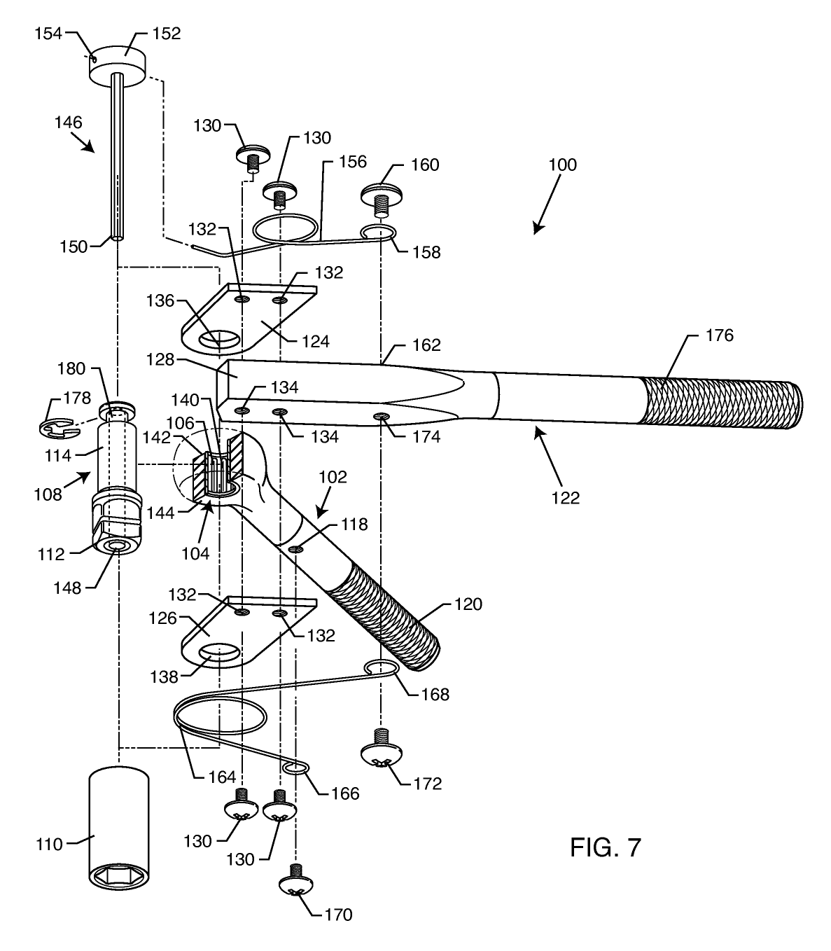

With reference now to FIGS. 5-7, the wrench 100 is generally comprised of a ratchet wrench having a handle 102 including a ratchet head 104 at an end thereof. For purposes of the invention, this can be a conventional ratchet wrench, a box ratchet, or more preferably as illustrated in FIG. 7, a ratchet wrench having a gearless ratchet clutch head 104. Such a gearless ratchet clutch mechanism includes the use of rollers or bearings 106 such that the handle 102 of the ratchet can be moved across any degree of arc and cause a driver 108 thereof to be rotated and rotate a socket 110 mated therewith. However, a box ratchet may be used for the ratcheting member, but such a ratchet requires a minimum of degrees of handle motion to engage the next tooth on the ratchet. If the handles cannot be opened the minimum arc and space from one another, the ratchet will not be able to function. The important aspect is that a ratchet wrench is used which can turn a socket, the wrench having a through hole and a ratcheting mechanism capable of being fitted with a socket for driving and rotating the threaded nut element of an air frame fastener.

With continuing reference to FIG. 7, an exemplary driver 108 is shown having a multi-faceted head 112, such as four facets, which can be releasably engaged with a corresponding recess of a socket 110. A spindle 114 of the driver 108 extends through the ratchet head 104 so as to engage the ratcheting mechanism, in the illustrated case a plurality of spaced apart rollers or bearings 106.

Internally threaded apertures or recesses 116 and 118 are formed in the ratchet handle 102 intermediate the ratchet head 104 and a grip end 120, as will be explained more fully herein.

A second handle 122 is pivotally connected to the first ratchet handle 102. Typically, an extension member extends at an acute angle from the second handle for pivotal connection to the ratchet end of the first handle. In the illustrated embodiment, first and second plates 124 and 126 are attached to an end 128 of the second handle 122, such as by the illustrated bolts 130 extending through threaded apertures 132 of the plates 124 and 126 and into corresponding threaded apertures 134 of the second handle 122. The plates extend from the shaft 128 of the handle 122 at an acute angle, generally aligned with one another such that an aperture 136 of the first plate 124 and an aperture 138 of the second plate 126 are generally aligned with a passageway 140 of the ratchet head 104. As such, the ends of the plates 124, 126 having the apertures 136 and 138 are disposed on top and bottom lands 142 and 144 of the ratchet head 104. The spaced apart first and second plates 124 and 126 collectively form an extension member extending at an acute angle from the shaft of the second handle 122, facilitating pivotal connection between the first and second handles 102 and 122. This forms a clevis fastener type of an arrangement. It will be appreciated by those skilled in the art that other arrangements enabling pivotal connection between the first and second handles 102 and 122 could be used.

A key 146 is inserted through the aligned apertures of the top plate 124, the ratchet head 104 and the bottom plate 126. More particularly, the key 146 extends through a passageway 148 extending the length of the driver 108. At least a first end 150 of the key has a plurality of exterior facets, typically in a hex configuration, which correspond with internal facets of the recess 18 of pin 10. Typically, these facets extend to a generally opposite end or head 152 of the key 146.

As described above, the key 146 is used to hold the pin 10 in place and prevent rotation of it as the nut element or collar 22 is attached to the threaded shank portion 16 thereof. As such, the key 146 is attached to the second handle 122 to prevent rotation thereof during operation. The second handle 122 is generally held immobile while the ratchet handle 102 is grasped by the user's fingers and moved back and forth towards and away from the second handle 122.

The head 152 of the key 146 includes a passageway 154 therethrough into which is extended an end of a connector element 156. The generally opposite end 158 of the connector element 156 is attached to the second handle 122, such as by means of the illustrated bolt 160 which extends into an internally threaded aperture 162 of the second handle 122 to hold the end 158 of the connector element 156 in place. Thus, the key 146 remains stationary and does not rotate as the second handle 122 is held in place while the first handle 102 is brought towards it during operation of the wrench 100.

In a particularly preferred embodiment, the connector element 156 comprises a resilient member, such as the illustrated spring, in order to enable the key 146 a degree of limited travel through the ratchet head 104 and driver 108. This short axial travel allows the key 146 to not only engage the internal facets of the fastener pin recess 18, but also allows the key 146 to be pushed up slightly so as to adjust to the changing position of the tip of the pin 10 relative to the wrench 100 as the collar or nut element 22 is threaded onto the pin 10.

In a preferred embodiment, a biasing member, such as the illustrated spring 164, is interconnected between the first and second handles 102 and 122 so as to bias the handles inward 122 away from one another. In the illustrated embodiment, generally opposite looped ends 166 and 168 of the spring biasing member 164 are attached to the handles 102 and 122, such as by means of bolts 170 and 172 extending into internally threaded apertures 118 of the first handle 102 and internally threaded aperture 174 of the second handle, between end of shaft 128 and a grip end 176 of the second handle 122. The spring member 164 serves to bias the handles 102 and 122, and particularly the free grip ends 122 and 176 of these handles, away from one another. In this manner, as the first ratchet handle 102 is brought towards the second handle 122, upon release the first handle 102 returns to its original spaced-apart position relative to the second handle 122.

With reference again to FIG. 7, the key 146 and the socket 110 may be interchangeable to fit a range of fasteners. A clip 178 is inserted into a recessed neck portion 180 of the driver 108 to hold the driver 108 to the ratchet head 104. The key 146 is insertable through the passageway 148 of the driver 108, so as to extend through the ratchet head 104. Once the appropriate key 146 has been selected, it is attached to the second handle 122 by means of the connector element 156, as described above. One end of socket 110 engages with the head 112 of the driver 108, as is well known in the industry. A set screw (not shown) may be used to fixedly connect the socket 110 and the driver 108 so that a secure connection therebetween is made.

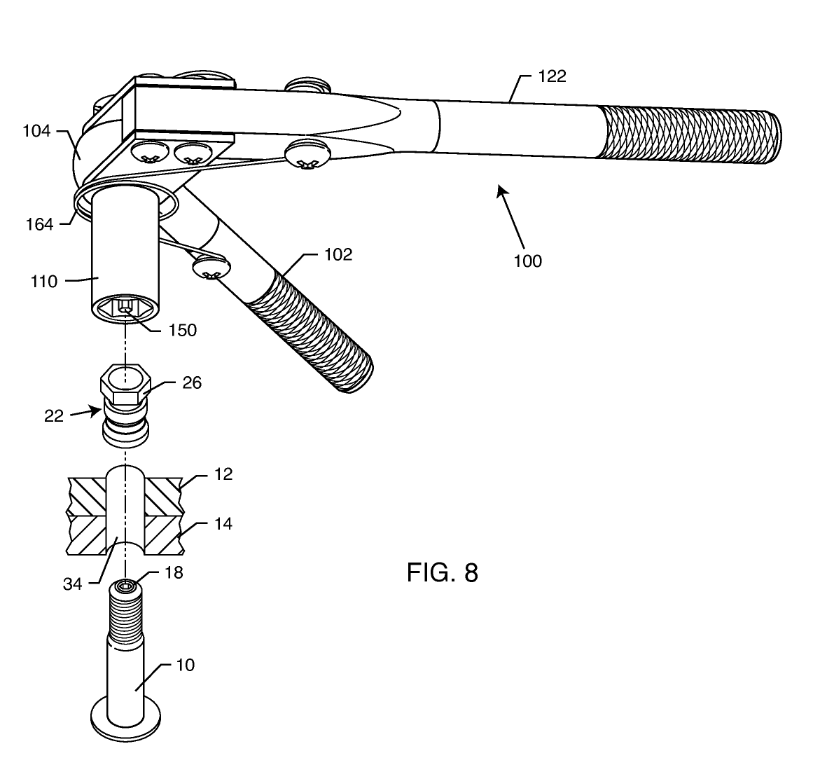

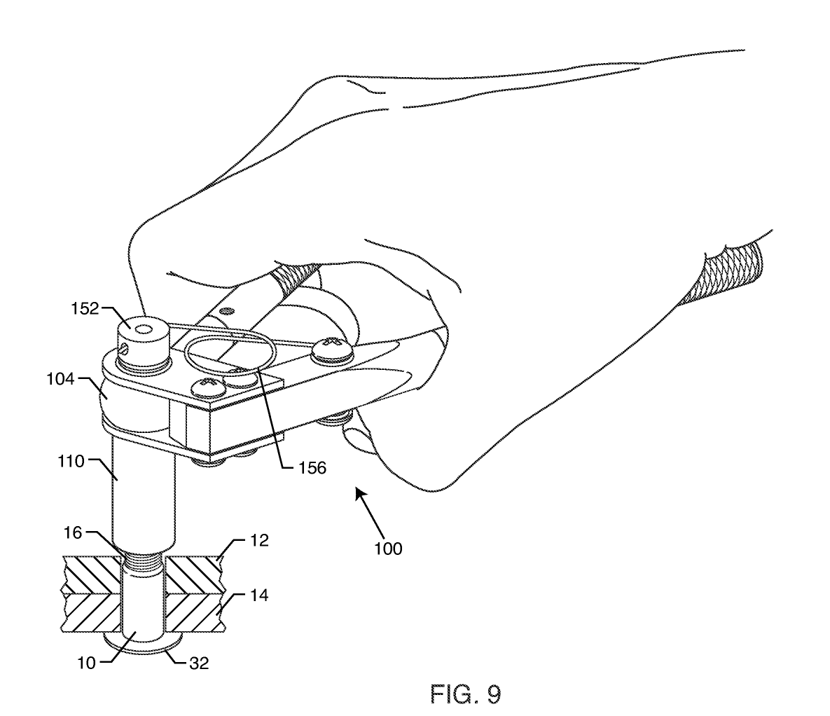

With reference now to FIGS. 8 and 9, in order to join two air frame objects 12 and 14 together, a pin 10, such as that described above, extends through aligned apertures 34 of the objects 12 and 14 such that a threaded shank portion 16 extends above object 12. The head of the pin 32, as illustrated in FIG. 9, rests against the exterior surface of the other object 14. With the appropriate sized socket 110 attached to the driver 108, the socket is placed over the faceted ring 26 of the nut element 22 and the internally threaded nut element 22 is rotated and fastened to the pin 10 as the first ratchet handle 102 is repeatedly brought towards and away from the second handle 122, as illustrated in FIG. 9. While this is occurring, the faceted end 150 of the key 146 is engaged with the internally faceted recess 18 of the pin 10, to prevent rotation thereof.

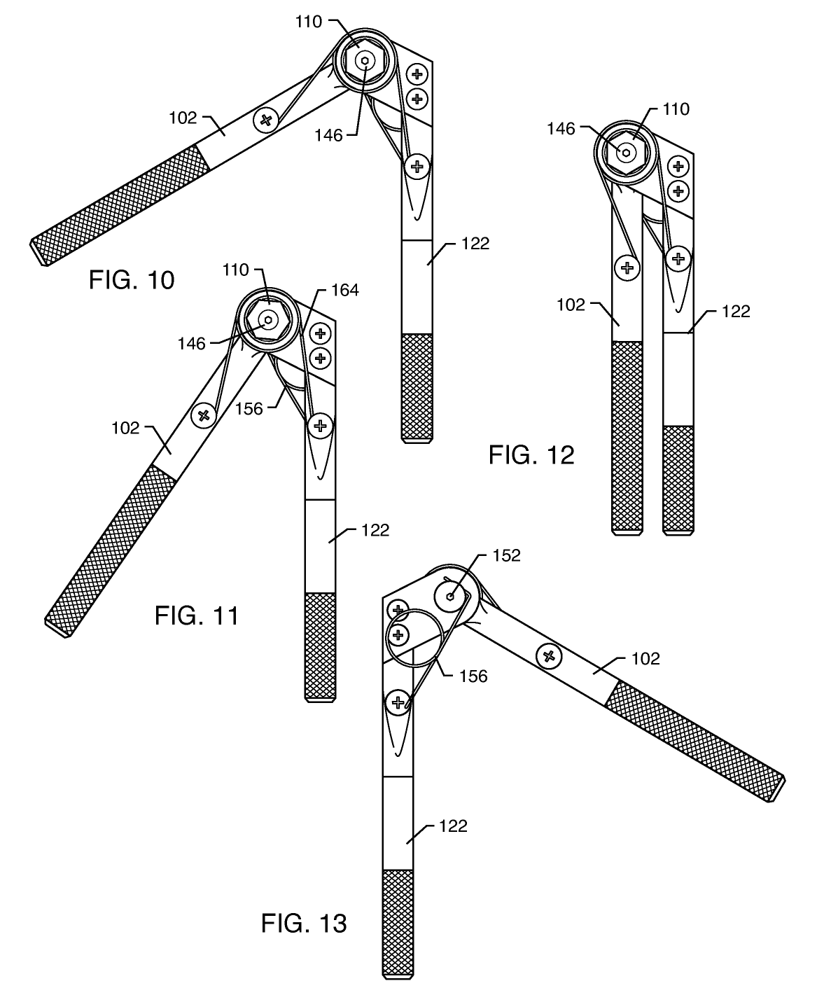

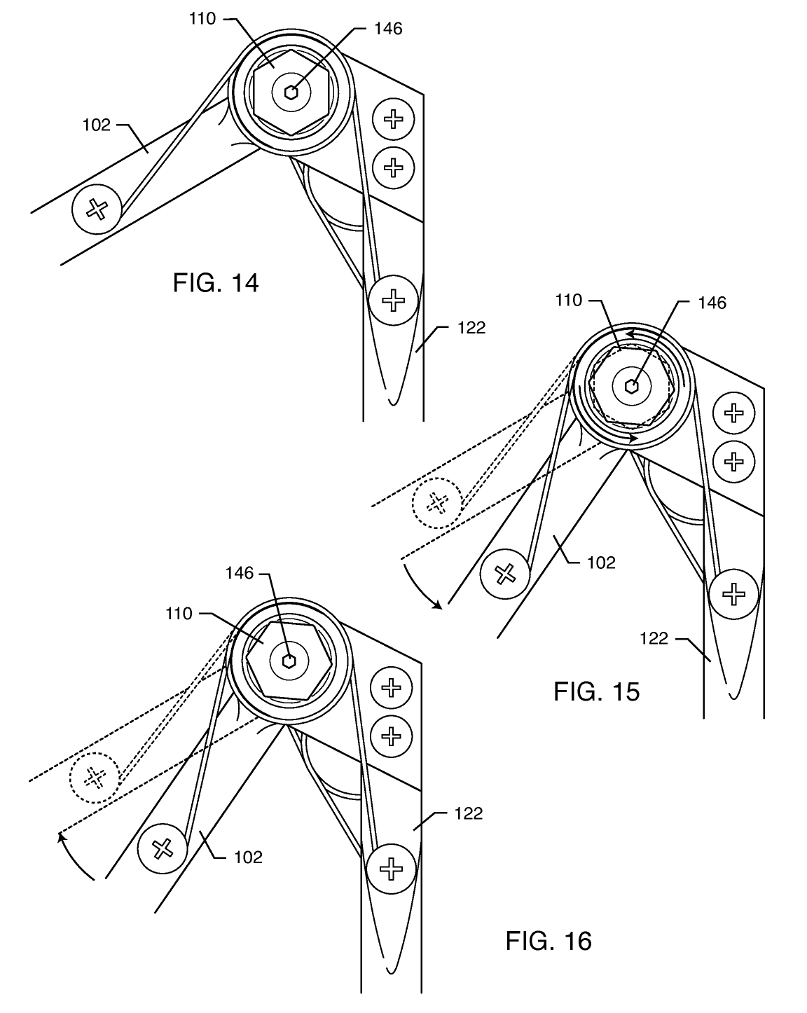

With reference now to FIGS. 10-16, it can be seen that while the first handle is brought towards the second handle 122, the driver, and thus the socket 110, is rotated while the key 146 does not rotate. It will also be seen, as illustrated in FIGS. 15 and 16, that after the first handle 102 of the ratchet has been moved towards the second handle 102, and then released, the first handle 102 automatically moves away from the second handle 122 due to the bias of spring 164.

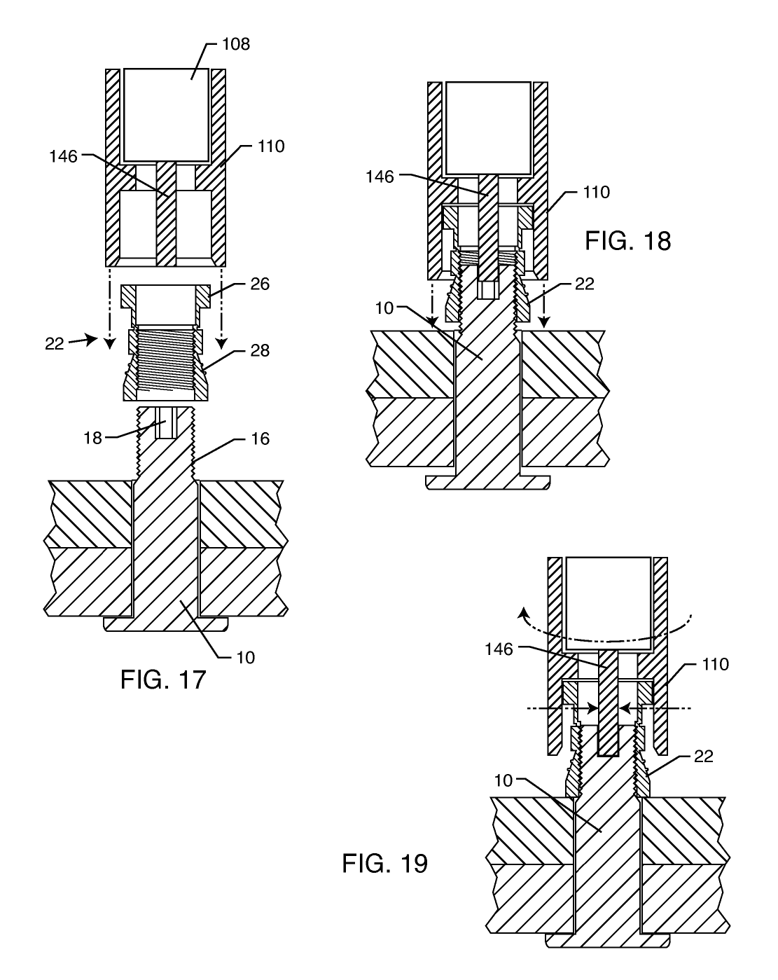

With reference now to FIGS. 17-23, it can be seen that the nut element 22, and more particularly the internally threaded collar portion 28 of the nut element 22 is disposed over and aligned with the exteriorally threaded shank 16 of the pin 10, with the socket 110 engaging the wrenching ring 26 portion of the nut element 22 while the key 146 extends through the hollow nut element and into the faceted recess 18 of the pin 10. As the first handle 102 is brought towards the second handle 122 in repeated fashion, the socket is rotated, thus rotating the nut element 22 and fastening it upon the shank 16 of pin 10, as illustrated in FIGS. 18 and 19. While this is occurring, the key 146 is engaged with the recess 18 of pin 10, and due to the fact that the key 146 is not rotated, prevents rotation of the pin 10 while the nut element 22 is fastened thereto.

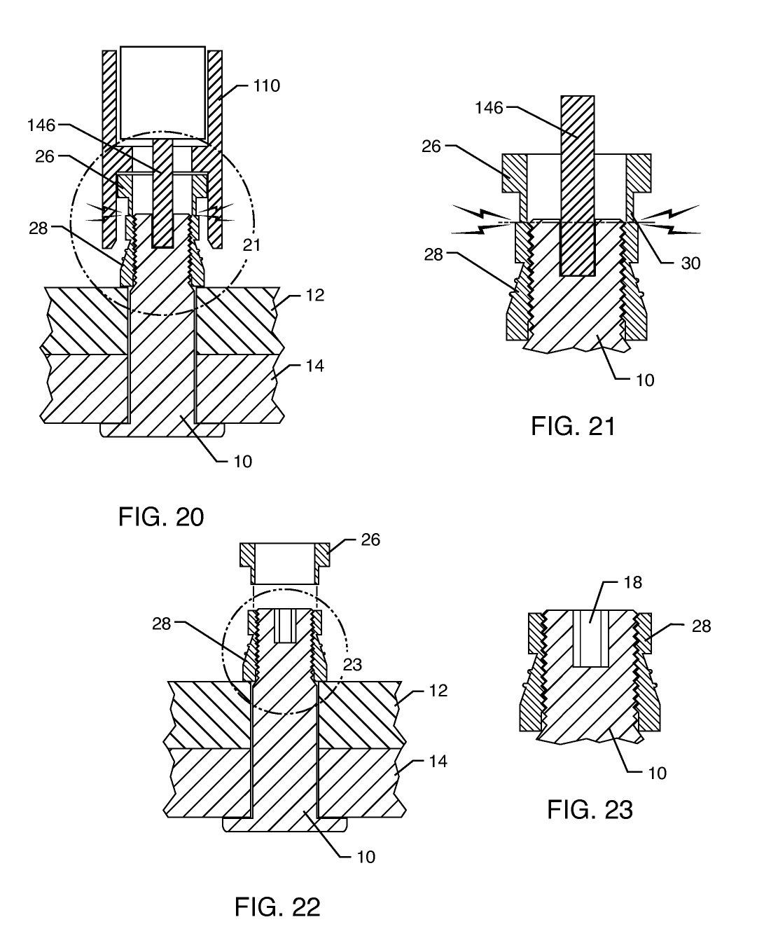

With reference now to FIGS. 20-23, and as described above, once the nut element 22 has been fastened to the pin 10 to a predetermined torque or degree, the wrenching ring 26 is sheared away from the internally threaded collar 28 at a neck portion 30 of reduced diameter, leaving the collar 28 threadedly connected to the pin 10, and thus fastening the objects 12 and 14 securely to one another. The air frame fastener wrench of the present invention provides sufficient torque to shear the frangible nut portion or wrenching ring 26 from the collar 28 when the collar 28 and pin 10 of the air frame fastener are adequately fastened to one another and a predetermined torque has been achieved.

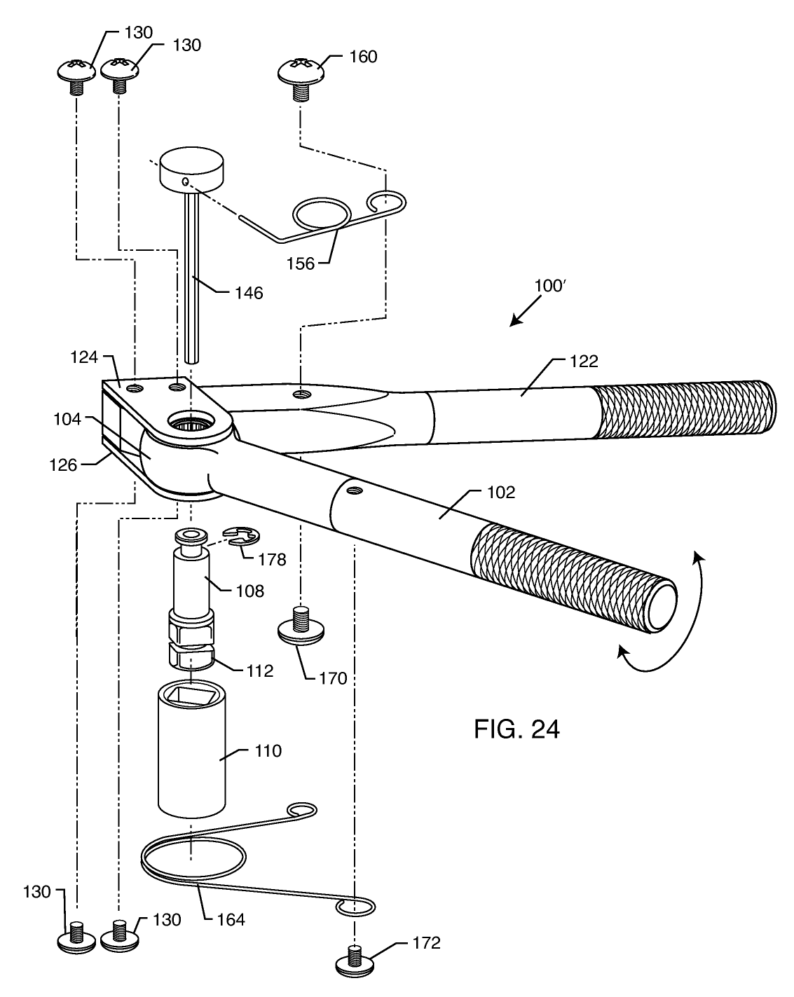

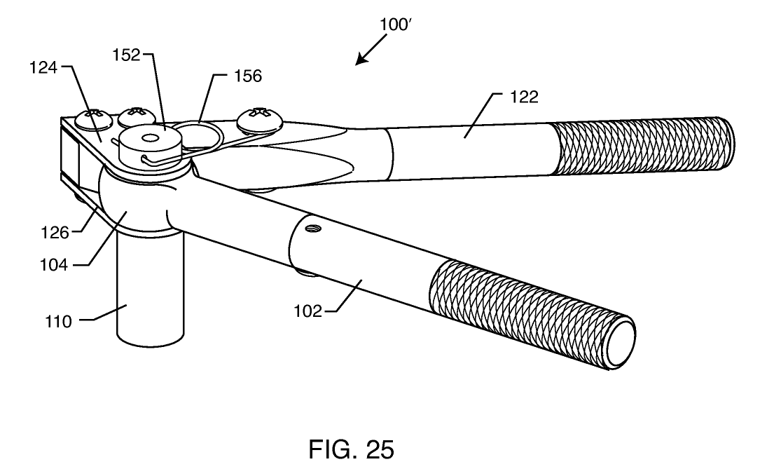

With reference now to FIGS. 24 and 25, the wrench of the present invention can be assembled to operate in the reverse, typically counterclockwise, direction for removal of the nut element 22, or even the attached collar 28 from the pin 10. This is achieved by simply rotating the ratchet wrench 102, such as illustrated by the rotational arrow, such that the top of the ratchet head 104 now becomes the bottom of the ratchet head between plates 124 and 126. The driver 108 is inserted into the ratcheting mechanism which has now been flipped one hundred eighty degrees such that the driver 108 is engaged and rotates in a counterclockwise direction as handle 102 is brought towards handle 122. The remaining components are attached as described above such that they key 146 is connected to the second handle 122 and engages pin 10 and prevents rotation of the pin 10 while loosening or removing the nut element 22. If the wrenching ring 26 portion of the nut element 22 has been previously removed and the collar 28 is completely fastened to the pin 10, instead of a hex socket 110, a special collar removal socket (such as the Omega Technologies, Inc. Savi-Socket or the OMSK3581 series sockets) are fitted to the head 112 of the driver 108 for removal of the collar 28 from the pin 10.

It will be appreciated by those skilled in the art that the two-handled wrench tool described above enables the tool to be operated around corners, out of sight, at arm's length, and with only a single hand to fasten or remove air frame fasteners to adjoining pieces of an air frame.

Although several embodiments have been described in detail for purposes of illustration, various modifications may be made without departing from the scope and spirit of the invention. Accordingly, the invention is not to be limited, except as by the appended claims.

What is claimed is:

1. An air frame fastener wrench, comprising:
a first handle having a ratchet head at a first end thereof, including a selectively rotatable driver mateable with a socket;
a second handle pivotally attached to the first handle;
a key extending through the ratchet head and attached to the first or second handle to prevent rotation of the key;
wherein as the first and second handles are brought towards one another, the driver rotates the mated socket and an engaged collar of an air frame fastener, while the key prevents rotation of a pin of the air frame fastener as the collar is tightened thereto.

2. The wrench of claim 1, wherein the key extends through the driver for insertion into a corresponding key recess of the pin of the air frame fastener.

3. The wrench of claim 2, wherein the key has a plurality of exterior facets corresponding to a plurality of interior facets of the air frame fastener pin key recess.

4. The wrench of claim 1, including a resilient member interconnecting the key and the first or second handle, permitting a limited travel of the key through the ratchet head.

5. The wrench of claim 1, including a biasing member connected to the first and second handles for biasing the first and second handles away from one another.

6. The wrench of claim 5, wherein the biasing member comprises a spring that biases free ends of the first and second handles away from one another.

7. The wrench of any one of claims 1-6, wherein the second handle comprises an extension member extending at an acute angle from a shaft of the second handle and pivotally connected to the ratchet end of the first handle.

8. The wrench of claim 7, wherein the extension member comprises first and second spaced apart plates disposed on top and bottom lands of the ratchet head.

9. The wrench of claim 8, wherein the first and second plates each include apertures through which the key and the driver extend.

10. The wrench of claim 1, wherein the ratchet head comprises a gearless ratchet clutch.

11. The wrench of claim 1, wherein the wrench provides torque sufficient to shear a frangible nut portion from the collar of the airframe fastener when the collar and pin are adequately fastened to one another.

12. An air frame fastener wrench, comprising:
a first handle having a ratchet head at a first end thereof, including a selectively rotatable driver mateable with a socket;
a second handle including an extension member extending at an acute angle from a shaft of the second handle and pivotally connected to the ratchet end of the first handle;
a biasing member connected to the first and second handles for biasing the first and second handles away from one another; and
a key extending through the ratchet head;
wherein as the first and second handles are brought towards one another, the driver rotates the mated socket and an engaged collar of an air frame fastener, while the key prevents rotation of a pin of the air frame fastener.

13. The wrench of claim 12, wherein the extension member comprises first and second spaced apart plates disposed on top and bottom lands of the ratchet head.

14. The wrench of claim 13, wherein the first and second plates each include apertures through which the key and the driver extend.

15. The wrench of any one of claims 12-14, wherein the key extends through the driver for insertion into a corresponding key recess of the pin of the air frame fastener.

16. The wrench of claim 15, wherein the key has a plurality of exterior facets corresponding to a plurality of interior facets of the air frame fastener pin key recess.

17. The wrench of any one of claims 12-14, wherein the key is connected to the first or second handle for preventing rotation of the key.

18. The wrench of claim 17, including a resilient member interconnecting the key and the first or second handle, permitting a limited travel of the key through the ratchet head.

19. The wrench of claim 12, wherein the biasing member comprises a spring that biases free ends of the first and second handles away from one another.

20. The wrench of claim 12, wherein the ratchet head comprises a gearless ratchet clutch.

21. The wrench of claim 12, wherein the wrench provides torque sufficient to shear a frangible nut portion from the collar of the airframe fastener when the collar and pin are adequately fastened to one another.
